(19) United States
(12) Patent Application Publication
(10) Pub. No.: US 2006/0183523 A1
(43) Pub. Date: Aug. 17, 2006

(54) Gaming machine

(75) Inventor: Hirobumi Toyoda, Tokyo (JP)

Correspondence Address: SNIDER & ASSOCIATES, P. O. BOX 27613, WASHINGTON, DC, 20038-7613, US

(73) Assignee: ARUZE Corp., Tokyo (JP)

(21) Appl. No.: 11/349,109

(22) Filed: Feb. 8, 2006

(30) Foreign Application Priority Data
Feb. 15, 2005 (JP) 2005-037872

(51) Int. Cl. A63F 9/24; G06F 19/00

(52) U.S. Cl. 463/10; 463/11; 463/12; 463/42

(57) ABSTRACT

In the gaming machine 101, if the number of players participating in the mah-jong game lies within a range of one player to four players (S12: YES), the mah-jong game with four players, in which the number of the mah-jong pieces (number pieces and character pieces) becomes four every kind of the mah-jong pieces, is conducted as the video game and scores are calculated according to the normal score table (S14, S15). And if the number of players participating in the mah-jong game is five (S12 NO, S13: YES), the mah-jong game with five players, in which the number of the mah-jong pieces (number pieces and character pieces) becomes five every kind of the mah-jong pieces, is conducted as the video game and scores are calculated according to the score table for five players (S16, S17). Further, if the number of players participating in the mah-jong game is six (S12 NO, S13: NO), the mah-jong game with six players, in which the number of the mah-jong pieces (number pieces and character pieces) becomes six every kind of the mah-jong pieces, is conducted as the video game and scores are calculated according to the score table for six players (S18, S19).

### CROSS-REFERENCE TO THE RELATED APPLICATION (S)

This application is based upon and claims a priority from the prior Japanese Patent Application No. 2005-037872 filed on February 15, the entire contents thereof are incorporated herein by reference.

### BACKGROUND OF THE INVENTION

1. Field of the Invention

The present invention relates to a gaming machine for conducting a video game in which a plurality of game tools are displayed in a state that such tools can be discriminated.

2. Description of Related Art

Conventionally, in a gaming machine for conducting a video game in which a plurality of game tolls are displayed in a state that such tolls can be discriminated, video games such as a mah-jong game utilizing mah-jong pieces or various trump card games utilizing trump cards are conducted. And in such video games, the mah-jong pieces or the trump cards are displayed on a display device by replacing those with images, as disclosed in Japanese Unexamined Utility Publication No. 4-70089 and in Japanese Unexamined Patent Publication No. 2001-70642.

By the way, in a case that the mah-jong game is conducted by utilizing real mah-jong pieces, four players generally participate in such mah-jong game, therefore a number of players is commonly four. The explanatory reason why four players participate in the mah-jong game is that such mah-jong game is not interesting if the mah-jong game is not conducted in a state that the mah-jong pieces of the other players cannot be seen.

However, in a case that the mah-jong game is conducted in the video game, as mentioned, since the real mah-jong pieces are replaced with images, it can be easily produced a state that the mah-jong pieces of the other players cannot be seen. In spite of that, such video mah-jong game is generally conducted by two or four players, thus the number of players is generally two or four. As mentioned, if the mah-jong game is conduced in the video game, the number of players participating in the game is fixed. Therefore, a strategy or sense of rhythm during the game becomes stereotyped, thus freshness is lost.

Here, as for a state concerning with the number of players participating in the game, such sate may occur in a case that the mah-jong game is conducted in the video game trough a network. Further, there may be substantially the same tendency as in a case that various trump games are conducted as the video games.

### SUMMARY OF THE INVENTION

Therefore, in order to dissolve the above problems, the present invention has an object to provide a gaming machine in which it can be expected a new game development with a mutually different strategy and sense of rhythm according to a number of players participating in a game even if the same kind of video game is conducted.

In order to accomplish the above object, according to one aspect of the present invention, it is provided a gaming machine comprising:

a display device for displaying image data of game tools;

a first memory for storing a plurality of score tables each of which is formed corresponding to a number of players participating in a game;

a second memory for storing the image data of the game tools;

a first determination device for determining the number of the players participating in the game;

a second determination device for determining a number of the game tools corresponding to the number of the players determined by the first determination device;

a table selection device for selecting one of the score tables stored in the first memory based on the number of the players determined by the first determination device; and

a game control device for executing the game based on the number of the game tools determined by the second determination device and the score table selected by the table selection device while controlling the display device so as to display the image data of the game tools corresponding to the number thereof determined by the second determination device.

In the gaming machine according to the present invention, since the number of the game tools and the score table utilized in the video game are determined corresponding to the number of the players participating in the game, it can be expected a new game development with a mutually different strategy and sense of rhythm according to the number of players participating in the game even if the same kind of the video game is conducted.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a perspective view showing a gaming machine according to the embodiment,

FIG. 2 is a plan view of the gaming machine according to the embodiment,

FIG. 3 is a plan view showing a control panel of the gaming machine according to the embodiment,

FIG. 4 is a block diagram showing an inner construction of the gaming machine according to the embodiment,

FIG. 5 is an explanatory view schematically showing an inner construction of a ROM in the gaming machine conducting a mah-jong game according to the embodiment,

FIG. 6 is a flowchart showing a part of a main program executed in the gaming machine conducting the mah-jong game according to the embodiment,

FIG. 7 is a plan view showing one example of display contents displayed on a display screen of the gaming machine according to the embodiment,

FIG. 8 is an explanatory view schematically showing an inner construction of the ROM in the gaming machine conducting a trump game according to the embodiment,

FIG. 9 is a flowchart showing a part of the main program executed in the gaming machine conducting the trump game according to the embodiment,

FIG. 10 is an image view showing contents of image data of suits in trump cards utilized in the gaming machine according to the embodiment,

FIG. 11 is an image view showing contents of image data of a rank in the trump cards utilized in the gaming machine according to the embodiment, and

FIG. 12 is an image view sowing one example of contents in which both the image data of the suits and the rank are synthesized, in the gaming machine according to the embodiment.

### DETAILED DESCRIPTION OF THE PREFERRED EMBODIMENTS

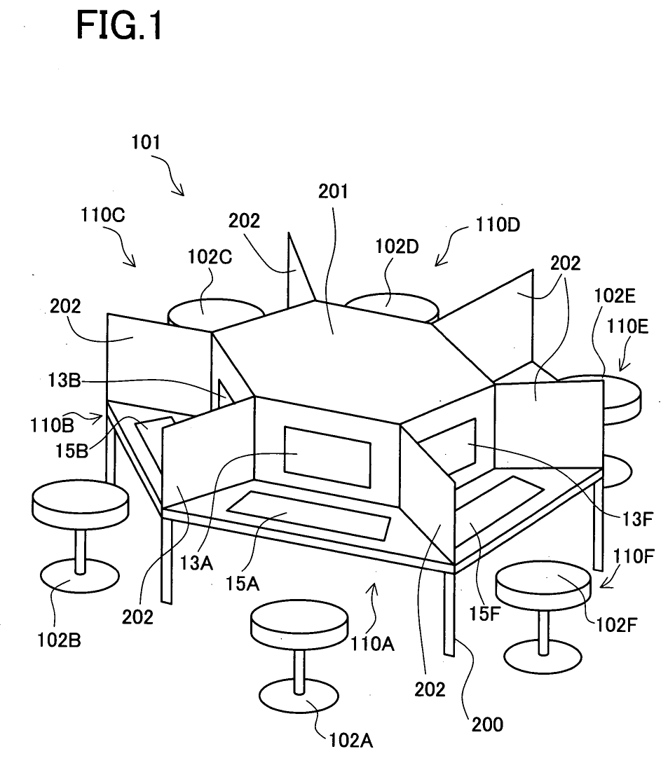

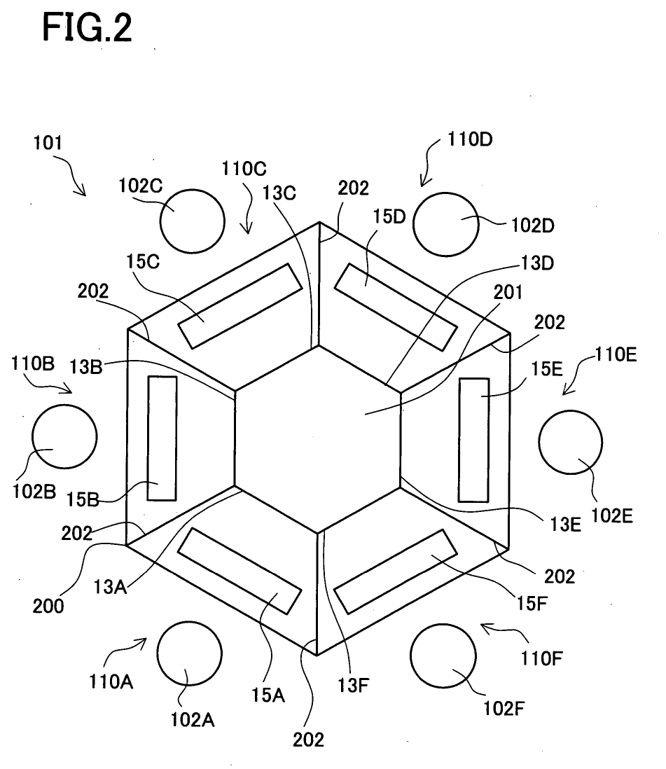

Hereinafter, the embodiment of the present invention will be described with reference to the drawings. FIG. 1 is a perspective view showing a gaming machine 101 according to the embodiment. FIG. 2 is a plan view showing the gaming machine 101 according to the embodiment. In the gaming machine 101 of the embodiment, a mah-jong game can be conducted in a form of a video game, and one to six players can participate in the mah-jong game.

Here, if four players participate in the mah-jong game, such mah-jong game is conducted in a proper form with four players. And if a number of players participating in the mah-jong game is less than four, lacking player (s) to construct the proper form are compensated under automatic control through a control portion (CPU). At that time, four number pieces for one kind of numbers and four character pieces for one kind of characters are respectively provided according to the proper form, and the mah-jong game is conducted with a proper score manner. On the other hand, if five players participate in the mah-jong game, such mah-jong game is conducted in a form with five players. At that time, five number pieces for one kind of numbers and five character pieces for one kind of characters, which are specific for the mah-jong game with five players, are respectively provided and the mah-jong game is conducted with a specific score manner for the mah-jong game with five players. Further, if six players participate in the mah-jong game, such mah-jong game is conducted in a form with six players. At that time, six number pieces for one kind of numbers and six character pieces for one kind of characters, which are specific for the mah-jong game with six players, are respectively provided and the mah-jong game is conducted with a specific score manner for the mah-jong game with six players.

And in the gaming machine 101 of the embodiment, as shown in FIGS. 1 and 2, a hexagonal post 201 is projected in a central position of a hexagonal game table 200 and each of sides of the game table 200 and each of side planes of the hexagonal post 201 are parallel arranged. Further, six shelter plates 202 are respectively stood toward each of six interior angles of the game table 200 from each of six ridge lines intersecting with sides of the hexagonal post 201.

And based on that the game table 200 is divided by six side planes of the hexagonal post 201 and six shelter plates 202, first to sixth gaming places 110A, 110B, 110C, 110D, 110E and 110F are provided on the game table 200, each of the gaming places being occupied by one player.

Here, in the first gaming place 110A, a first control panel 15A is arranged on the game table 200 and a first display screen 13A is arranged on the side plane of the hexagonal post 201. And a first seat 102A on which one player can sit is fixed outside of the game table 200.

Here, above situation is as same as that in each of the second to sixth gaming places. That is to say, second to sixth control panels 15B, 15C, 15D, 15E and 15F are respectively arranged on the game table 200 and second to sixth screens 13B, 13C, 13D, 13E and 13F are respectively arranged on each of the side planes of the hexagonal post 201. And second to sixth seats 102B, 102C, 102D, 102D 102E and 102F on each of which one player can sit are respectively fixed outside of the game table 200.

Therefore, in each of the first to sixth gaming places 110A, 110B, 110C, 110D, 110E, 110E and 110F, if a player sits on each of the first to sixth seats 102A, 102B, 102C, 102D, 102E and 102F, each of the first to sixth display screens 13A, 13B, 13C, 13D, 13E and 13F and each of the first to sixth control panels 15A, 15B, 15C, 15D, 15E and 15F are positioned right opposite to each player.

And a height of the hexagonal post 201 and each of the shelter plates 202 is designed so as to satisfy the following point, based on that a height of eye sight of each player, who sits on each of the first to sixth seats 102A, 102B, 102C, 102D, 102E and 102F, is estimated in a predetermined range which is made as a standard. Here, the above point is that each player sitting on each of the first to sixth seats 102A, 102B, 102C, 102D, 102E and 102F cannot see the first to sixth display screens 13A, 13B, 13C, 13D, 13E and 13F positioned right opposite to the other players, and the first to sixth control panels 15A, 15B, 15C, 15D, 15E and 15F of the other players, by being blocked through the hexagonal post 201 and each of the shelter plates 202, and on the other hand, each player can mutually see faces of the other players without being blocked through the hexagonal post 201 and each of the shelter plates 202.

Here, in the embodiment, as mentioned, although eye sight of each player is blocked by the hexagonal post 201 on the side planes of which the first to sixth display screens 13A, 13B, 13C, 13D, 13E and 13F are arranged, it is not limited to this construction. For example, eye sight of each player may be blocked by cabinets of the first to sixth display screens 13A, 13B, 13C, 13D, 13E and 13F, without providing the hexagonal post 201.

Next, each of the first to sixth control panels 15A, 15B, 15C, 15D, 15E and 15F will be described. Here, as for each of the first to sixth control panels 15A, 15B, 15C, 15D, 15E and 15F, all of them are same, thus the first control panel 15A arranged in the first gaming place 110A will be described as an example of the control panel.

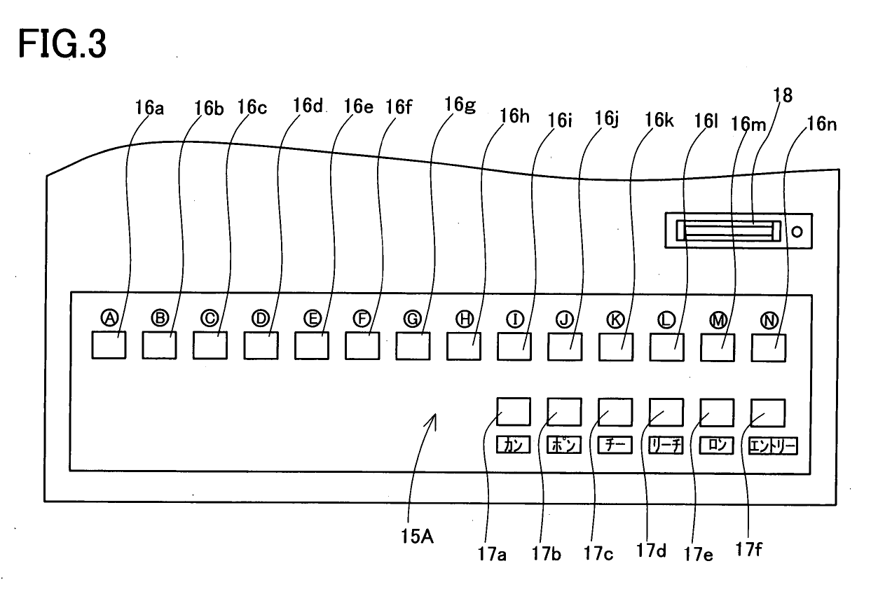

FIG. 3 is a plan view schematically showing the first control panel 15A. As shown in FIG. 3. there are provided in the first control panel 15A fourteen operation buttons 16 (16a˜16n) arranged at the upper side (in FIG. 3, distant side) and six operation buttons 17 (17a˜17f) arranged at the lower side (in FIG. 3, near side). And at the right upper side of the fourteen buttons 16, a coin insertion slot 18 is provided.

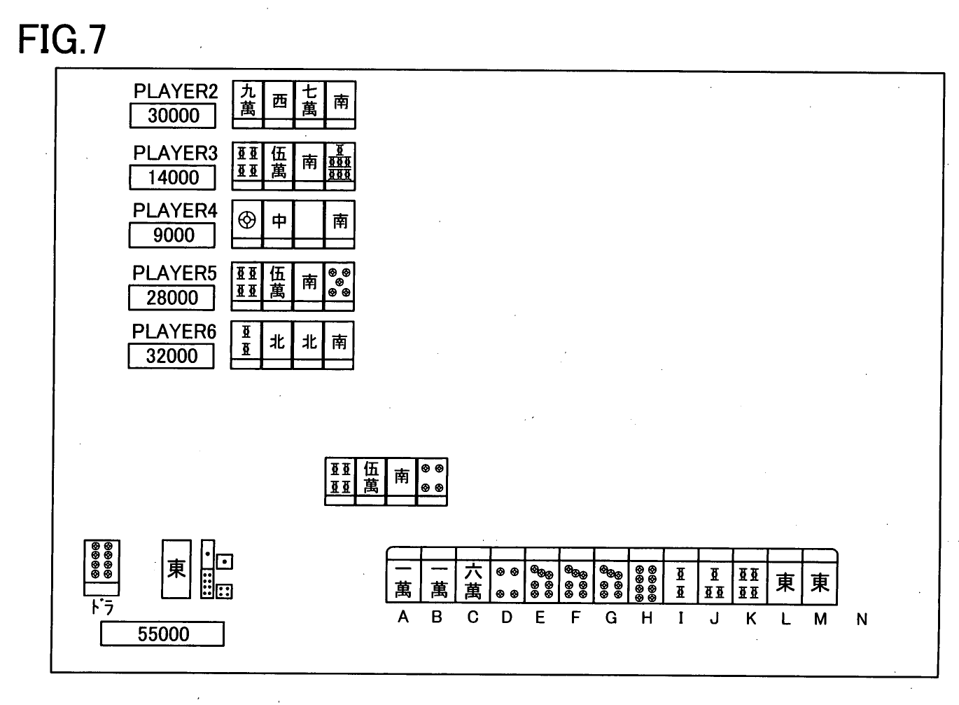

The fourteen operation buttons 16 (16a˜16n), each of which is represented by one alphabet enclosed in a circle, respectively corresponds to each of fourteen mah-jong pieces which are the pieces dealt to the player and displayed on the first display screen 13A (see FIG. 7). When the pieces dealt to the player are thirteen and the operation button 16a is pressed, an operation to take one piece is done, thereby a new piece is displayed at the right position (position corresponding to the operation button 16n) of thirteen pieces displayed on the first display screen 13A and the pieces of the player become fourteen. And when the player selects one piece unnecessary for the player among fourteen pieces of the player and presses the operation button corresponding to the selected piece, an operation to throw away the selected piece is conducted. Thereby, based on that the piece unnecessary for the player is deleted from the pieces of the player, the pieces of the player become thirteen and the thrown piece is newly displayed on the first display screen 13A.

Among six operation buttons 17 (17a˜17f), the operation buttons 17a˜17e correspond to game actions [symbol] (action to collect four pieces with the same number or character), [symbol] (action to collect three pieces with the same number or character), [symbol] (action to collect three continuous pieces with the same kind by combining with one piece retained by the player), [symbol] (action to proclaim that the pieces become a state capable of finishing the mah-jong game) and [symbol] (action to finish the mah-jong game), respectively. And the operation button 17f is an entry button which is pressed when the player participates in the mah-jong game after inserting a coin through the coin insertion slot 18.

The above points described are as same as those in each of the second to sixth control panels 15B, 15C, 15D, 15E and 15F which are respectively provided in the second to sixth gaming places 110B, 110C, 110D, 110E and 110F.

And the players sitting on the first to sixth seats 102A, 102B, 120C, 102D, 102E and 102F respectively operate the first to sixth control panels 15A, 15B, 15C, 15D, 15E and 15F each of which has the operation buttons 16a˜16n and the operation buttons 17a˜17f, thereby each player serially changes the pieces thereof. On the other hand, if the player (s) is compensated by the automatic control through the control portion (CPU), the pieces are serially changed by the automatic control through the control portion (CPU).

And the players sitting on the first to sixth seats 102A, 102B, 102C, 102D, 102E and 102F can respectively see the pieces of their own and all of the pieces thrown away by all of the players and a specific piece (called as [symbol] ) based on which the player can automatically obtain one more award when the pieces include such specific piece), as shown in FIG. 7.

Here, FIG. 7 is an explanatory view showing one example of display contents displayed on the display screen for the player corresponding to “PLAYER 1”. The player corresponding to “PLAYER 1” can see the pieces thrown away by the players respectively corresponding to “PLAYER 2”, “PLAYER 3”, “PLAYER 4”, “PLAYER 5” and “PLAYER 6”. Here, when the mah-jong game with five players is conducted, the player corresponding to “PLAYER 1” can see on the display screen the pieces thrown away by the players respectively corresponding to “PLAYER 2”, “PLAYER 3”, “PLAYER 4” and “PLAYER 5”. And when the mah-jong game with four players is conducted, the player corresponding to “PLAYER 1” can see the pieces thrown away by the players respectively corresponding to “PLAYER 2”, “PLAYER 3”, “PLAYER 4”. This situation is similarly done on the display screens of the players corresponding to “PLAYER 2”, “PLAYER 3”, “PLAYER 4”, “PLAYER 5” and “PLAYER 6”.

And the actions to take one piece and to throw one piece conducted by the players (including actions compensated by the automatic control through the control portion (CPU)) are reciprocally repeated while inserting actions [symbol] , [symbol] and the like according to a case. And when the pieces of the players (including the player (s) compensated by the automatic control through the control portion (CPU)) become any of combinations corresponding to plural winning combinations (for example, [symbol] , [symbol] and the like), the player wins the mah-jong game. Thereby, the player winning the mah-jong game can obtain a score corresponding to the winning combination (s) from the other players (including the player (s) compensated by the automatic control through the control portion (CPU)).

Here, in the embodiment, although change of the pieces of the player is serially conducted by operating the operation buttons 16, 17 on each of the first to sixth control panels 15A, 15B, 15C, 15D, 15E and 15F, the gaming machine 101 according to the embodiment may be constructed so that display corresponding to the operation buttons 16, 17 is conducted on each of the first to sixth display screens 13A, 13B, 13C, 13D, 13E and 13F and the above operation is done by clicking the operation buttons 16, 17. Or by clicking portions on which the pieces are displayed, the above operation may be done.

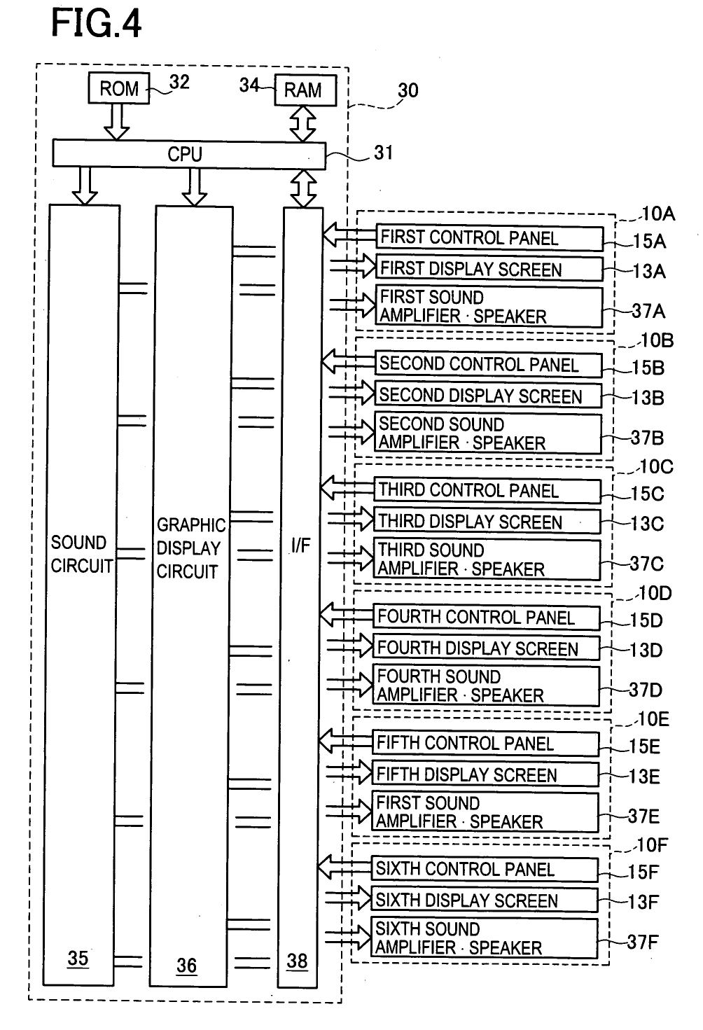

FIG. 4 is a block diagram schematically showing an inner construction of the gaming machine 101. Within the hexagonal post 201 of the gaming machine 101 a control portion 30 shown in FIG. 4 is provided. The control portion 30 has a CPU (Central Processing Unit) 31, a ROM (Read Only Memory) 32 and a RAM (Random Access memory) 34.

On the other hand, in the first to sixth gaming places 110A, 110B, 110C, 110D, 110E and 110F, as mentioned, there are provided the first to sixth display screens 13A, 13B, 13C, 13D, 13E and 13F and the first to sixth control panels 15A, 15B, 15C, 15D, 15E and 15F, respectively (see FIGS. 1 and 2). Further, in the first to sixth gaming places 110A, 110B, 110C, 110D, 110E and 110F, the first to sixth sound amplifier•speakers 37A, 37B, 37C, 37D, 37D, 37E and 37F are provided, respectively.

The CPU 31 is connected to each of the first to sixth control panels 15A, 15B, 15C, 15D, 15E and 15F through an interface circuit (I/F) 38. The CPU 31 conducts various processes based on control signals output from the first to sixth control panels 15A, 15B, 15C, 15D, 15E and 15F and progresses the mah-jong game.

And the CPU 31 is connected to the first to sixth display screens 13A, 13B, 13C, 13D, 13E and 13F through a graphic display circuit 36 and controls the display screens so as to display contents of the mah-jong game on the first to sixth display screens 13A, 13B, 13C, 13D, 13E and 13F, as shown in FIG. 7.

Further, the CPU 31 is connected to the first to sixth sound amplifier•speakers 37A to 37F through a sound circuit 35 and outputs sounds of the mah-jong game and music from the first to sixth sound speakers 37A to 37F corresponding to progress state of the mah-jong game.

On the other hand, in the RAM 34, work areas necessary when the CPU 31 conducts various processes are formed and various data such as win-loss data are stored in the work areas of the RAM 34.

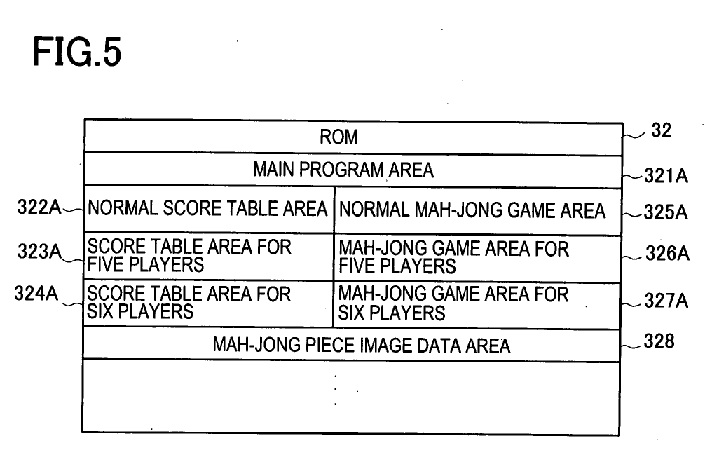

And in the ROM 32, as shown in FIG. 5, there are formed a main program area 321A, a normal score table area 322A, a score table area 323A of the mah-jong game with five players, a score table area 324A of the mah-jong game with six players, a normal mah-jong game area 325A, a mah-jong game area 326A of the mah-jong game with five players, a mah-jong game area 327A of the mah-jong game with six players and an image data area 328 for the mah-jong pieces.

Here, in the main program area 321A, a main program for controlling entire stream of the mah-jong game conducted in the gaming machine 101. And in the normal score table area 322A, it is stored a normal score table with the score manner in a case that the mah-jong game with four players is conducted. And in the score table area 323A of the mah-jong game with five players, it is stored a score table with the score manner in a case that the mah-jong game with five players is conducted. And in score table area 324A of the mah-jong game with six players, it is stored a score table with the score manner in a case that the mah-jong game with six players is conducted.

Further, in normal mah-jong game area 325A, it is stored a mah-jong game control program for controlling entire stream of the mah-jong game in a case that the mah-jong game with four players is conducted. Here, according to this mah-jong game control program, the first to sixth display screens 13A, 13B, 13C, 13D, 13E and 13F are controlled through the graphic display circuit 36, thereby the mah-jong game with four players is developed so that the number of the mah-jong pieces (number pieces and character pieces) becomes four every kind of the mah-jong pieces. And in the mah-jong game area 326A of the mah-jong game with five players, it is stored a mah-jong game control program for controlling entire stream of the mah-jong game in a case that the mah-jong game with five players is conducted. Here, according to this mah-jong game control program, the first to sixth display screens 13A, 13B, 13C, 13D, 13E and 13F are controlled through the graphic display circuit 36, thereby the mah-jong game with five players is developed so that the number of the mah-jong pieces (number pieces and character pieces) becomes five every kind of the mah-jong pieces. And in the mah-jong game area 327A of the mah-jong game with six players, it is stored a mah-jong game control program for controlling entire stream of the mah-jong game in a case that the mah-jong game with six players is conducted. Here, according to this mah-jong game control program, the first to sixth display screens 13A, 13B, 13C, 13D, 13E and 13F are controlled through the graphic display circuit 36, thereby the mah-jong game with six players is developed so that the number of the mah-jong pieces (number pieces and character pieces) becomes six every kind of the mah-jong pieces.

And in the image data area 328 for the mah-jong pieces, there are stored images of the mah-jong pieces (number pieces and character pieces) displayed on the first to sixth display screens 13A, 13B, 13C, 13D, 13E and 13F and the other image data.

Here, although not shown in FIG. 5, in the RAM 32, it is formed an area in which output data of the first to sixth sound amplifier•speakers 37A to 37F are stored.

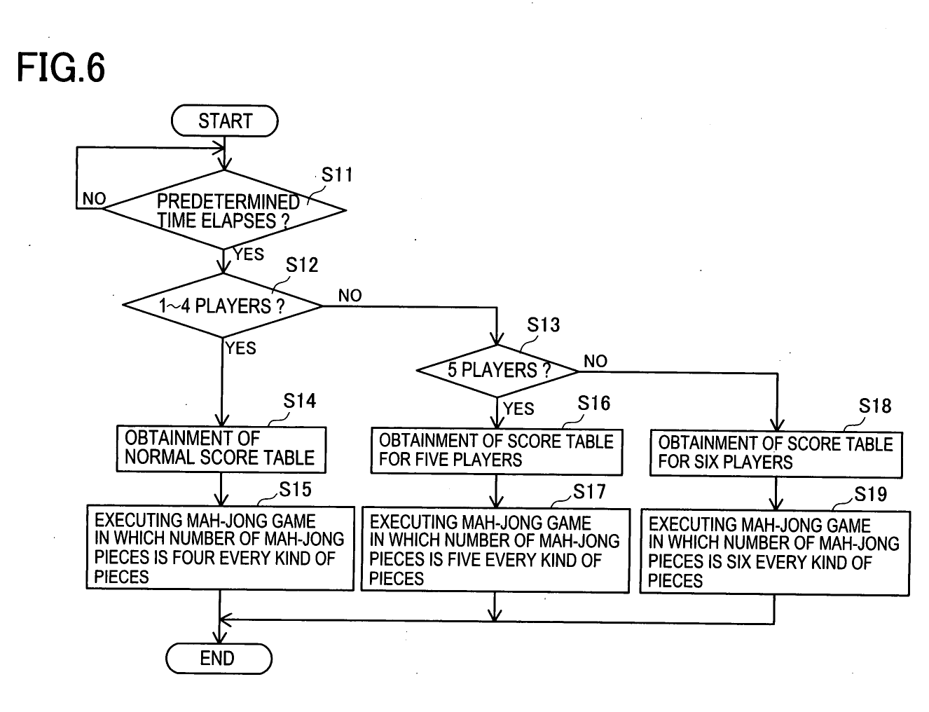

Next, it will be described a part of the main program executed by the CPU 31 in the gaming machine 101 of the embodiment. FIG. 6 is a flowchart showing a part of the main program. In the gaming machine 101 according to the embodiment, as shown in FIG. 6, at first, procedure waits till a predetermined time (for example, one minute) elapses in S11. And if it is determined that the predetermined time elapses (S11: YES), an entry number is determined in S12 and S13.

Here, the entry number is determined based on the number of the operation buttons 17f pressed in each of the first to sixth control panels 15A, 15B, 15C, 15D, 15E and 15F till the predetermined time in S11 elapses.

If it is determined that the entry number lies in a range of one player to four players (S12: YES), procedure shifts to S14. In S14, the normal score table stored in the normal score table area 322A of the ROM 32 is obtained and stored in the work area of the RAM 34. Procedure further shifts to S15 and the mah-jong game control program stored in the normal mah-jong game area 325A of the ROM 32 is obtained and stored in the work area of the RAM 34 and such mah-jong game program is executed. Thereby, thereafter the number of the mah-jong pieces (number pieces and character pieces) becomes four every kind of the mah-jong pieces based on the operation signals output from the operation buttons 16, 17 on the first to sixth control panels 15A, 15B, 15C, 15D, 15E and 15F. And the mah-jong game with four players is conducted as the video game and scores are calculated according to the normal score table. In this case, the above mah-jong game is as same as the mah-jong game generally done, and if the entry number lies within a range of one player to three players, the player (s) lacking for the normal mah-jong game is compensated by the automatic control through the CPU 31.

On the other hand, if it is determined that the entry number is five players (S12: NO, S13: YES), procedure shifts to S16 and the score table for five players stored in the score table area 323A of the mah-jong game with five players of the ROM 32 is obtained and stored in the work area of the RAM 34 and procedure shifts to S17. In S17, the mah-jong game control program stored in the mah-jong game area 326A of the mah-jong game with five players is obtained and stored in the work area of the RAM 34 and such mah-jong game control program is executed. Thereby, thereafter based on the operation signals output from the operation buttons 16, 17 on the first to sixth control panels 15A, 15B, 15C, 15D, 15E and 15F, the mah-jong game with five players, in which the number of the mah-jong pieces (number pieces and character pieces) becomes five every kind of the mah-jong pieces, is conducted as the video game and scores are calculated according to the score table for five players.

And if it is determined that the entry number is six players (S12: NO, S13: NO), the score table for six players stored in the score table area 324A of the mah-jong game with six players of the ROM 32 is obtained and stored in the work area of the RAM 34 and procedure shifts to S19. In S19, the mah-jong game control program stored in the mah-jong game area 327A of the mah-jong game with six players is obtained and stored in the work area of the RAM 34 and such mah-jong game program is executed. Thereby, thereafter based on the operation signals output from the operation buttons 16, 17 on the first to sixth control panels 15A, 15B, 15C, 15D, 15E and 15F, the mah-jong game with six players, in which the number of the mah-jong pieces (number pieces and character pieces) becomes six every kind of the mah-jong pieces, is conducted as the video game and scores are calculated according to the score table for six players.

Here, if it is determined in S12 that the entry number is zero (0), procedure returns to S11 and again waits till the predetermined time elapses although not shown in FIG. 6.

As mentioned in the above, in the gaming machine 101 of the embodiment, based on that the players sitting on the first to sixth seats 102A, 102B, 102C, 102D, 102E and 102F in the first to sixth gaming places 110A, 110B, 110C, 110D, 110E and 110F press the operation button 17f provided in the first to sixth control panels 15A, 15B, 15C, 15D, 15E and 15F till the predetermined time elapses, the players can participate in the mah-jong game (S11, S12, S13).

At that time, if the number of players participating in the mah-jong game lies within a range of one player to four players (S12: YES), the mah-jong game with four players, in which the number of the mah-jong pieces (number pieces and character pieces) becomes four every kind of the mah-jong pieces, is conducted as the video game and scores are calculated according to the normal score table (S14, S15). And if the number of players participating in the mah-jong game is five (S12 NO, S13: YES), the mah-jong game with five players, in which the number of the mah-jong pieces (number pieces and character pieces) becomes five every kind of the mah-jong pieces, is conducted as the video game and scores are calculated according to the score table for five players (S16, S17). Further, if the number of players participating in the mah-jong game is six (S12 NO, S13: NO), the mah-jong game with six players, in which the number of the mah-jong pieces (number pieces and character pieces) becomes six every kind of the mah-jong pieces, is conducted as the video game and scores are calculated according to the score table for six players (S18, S19).

That is to say, in the gaming machine 101 of the embodiment, since the mah-jong pieces (number pieces and character pieces) utilized in the mah-jong game as the video game and the score table are determined corresponding to the number of players participating in the mah-jong game, it can be expected a new game development with a mutually different strategy and sense of rhythm according to the number of players participating in the mah-jong game even if one kind of the video game such as the mah-jong game is conducted.

And in the gaming machine according to the embodiment, if the number of players sitting on the first to sixth seats 102A, 102B, 102C, 102D, 102E and 102F arranged in the first to sixth gaming places 110A, 110B, 110C, 110D, 110E and 110F provided on one game table 200 lies in a range of two players to six players, although the player cannot see the first to sixth display screens 13A, 13B, 13C, 13D, 13E and 13F positioned right opposite to the other players when the other players sit toward the hexagonal post 201 and the first to sixth control panels 15A, 15B, 15C, 15D, 15E and 15F, the players can mutually see the faces of the other players. Therefore, each of the players can enjoy bargaining while mutually watching the faces of the other players.

Here, the present invention is not limited to the above embodiment, and various modifications and changes can be done within the scope of the present invention.

For example, in the gaming machine 101 of the embodiment, although the mah-jong game is conducted, various trump games may be conducted. In this case, each of the first to sixth control panels 15A, 15B, 15C, 15D, 15e and 15F should be changed to those for the trump game. However, according to contents of the trump game, the first to sixth control panels 15A, 15B, 15C, 15D, 15E ad 15F can be used intact. In this case, the player can enjoy both the mah-jong game and the trump game in one gaming machine.

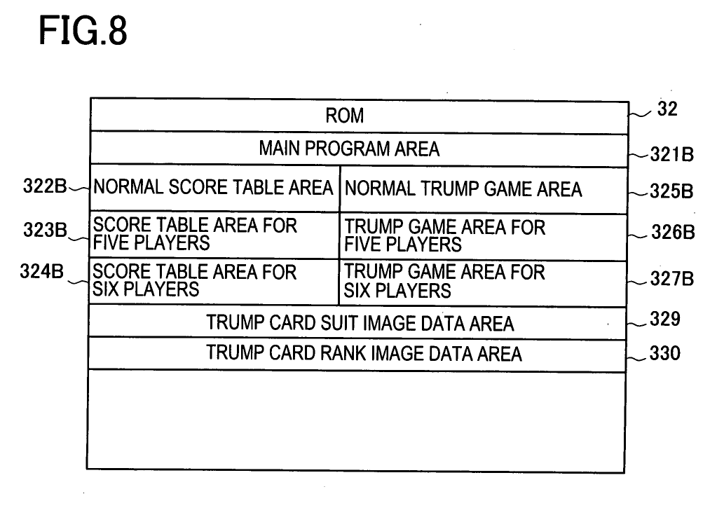

And an inner construction of the ROM 32 is formed as shown in FIG. 8. That is to say, in the ROM 32, as shown in FIG. 8, there are provided a main program area 321B, a normal score table area 322B, a score table area 323B of the trump game with five players, a score table area 324B of the trump game with six players, a normal trump game area 325B, a trump game area 326B of the trump game with five players, a trump game area 327B of the trump game with six players, a trump card suit image data area 329 and a trump card rank image data area 330.

Here, in the main program area 321B, a main program for controlling entire stream of the trump game conducted in the gaming machine 101. And in the normal score table area 322B, it is stored a normal score table with the score manner in a case that the normal trump game with four players is conducted. And in the score table area 323B of the trump game with five players, it is stored a score table with the score manner in a case that the trump game with five players is conducted. And in score table area 324B of the trump game with six players, it is stored a score table with the score manner in a case that the trump game with six players is conducted.

Further, in normal trump game area 325B, it is stored a trump game control program for controlling entire stream of the trump game in a case that the trump game with four players is conducted. Here, according to this trump game control program, the first to sixth display screens 13A, 13B, 13C, 13D, 13E and 13F are controlled through the graphic display circuit 36, thereby the trump game with four players is developed so that the number of the trump cards becomes four every kind of the trump cards. And in the trump game area 326B of the trump game with five players, it is stored a trump game control program for controlling entire stream of the trump game in a case that the trump game with five players is conducted. Here, according to this trump game control program, the first to sixth display screens 13A, 13B, 13C, 13D, 13E and 13F are controlled through the graphic display circuit 36, thereby the trump game with five players is developed so that the number of the trump cards becomes five every kind of the trump cards. And in the trump game area 327B of the trump game with six players, it is stored a trump game control program for controlling entire stream of the trump game in a case that the trump game with six players is conducted. Here, according to this trump game control program, the first to sixth display screens 13A, 13B, 13C, 13D, 13E and 13F are controlled through the graphic display circuit 36, thereby the trump game with six players is developed so that the number of the trump cards becomes six every kind of the trump cards.

And in the trump card suit image data area 329, image data of the trump cards on which six suits are described are stored. Here, six suits are club, diamond, heart, spade, circle and square, as shown in FIG. 10.

And in the trump card rank image data area 330, image data of the trump cards on which thirteen ranks are described are stored. Here, thirteen ranks are A (Ace), 2, 3, 4, 5, 6, 7, 8, 9, 10, J (Jack), Q (Queen) and K (King).

And these image data are synthesized in the work area retained in the RAM 34, thereby image data of the trump cards are formed. For example, if the rank A (Ace) is synthesized with each of six suits, image data of six trump cards are formed as shown in FIG. 12. Here, when image data of the trump cards are synthesized and any of the trump game with four players, the trump game with five players and the trump game with six players is conducted, all of thirteen ranks A, 1, 2, 3, 4, 5, 6, 7, 8, 9, 10, J, Q and K are used. And if the normal trump game is developed, four suits of club, diamond, heart and spade are used, if the trump game with five players is developed, five suits of club, diamond, heart, spade and circle are used, and if the trump game with six players is developed, six suits of club, diamond, heart, spade, circle and square are used.

Here, although as not shown in FIG. 8, in the ROM 32, it is provided an area for storing output data of the first to sixth sound amplifier•speaker 37A to 37F.

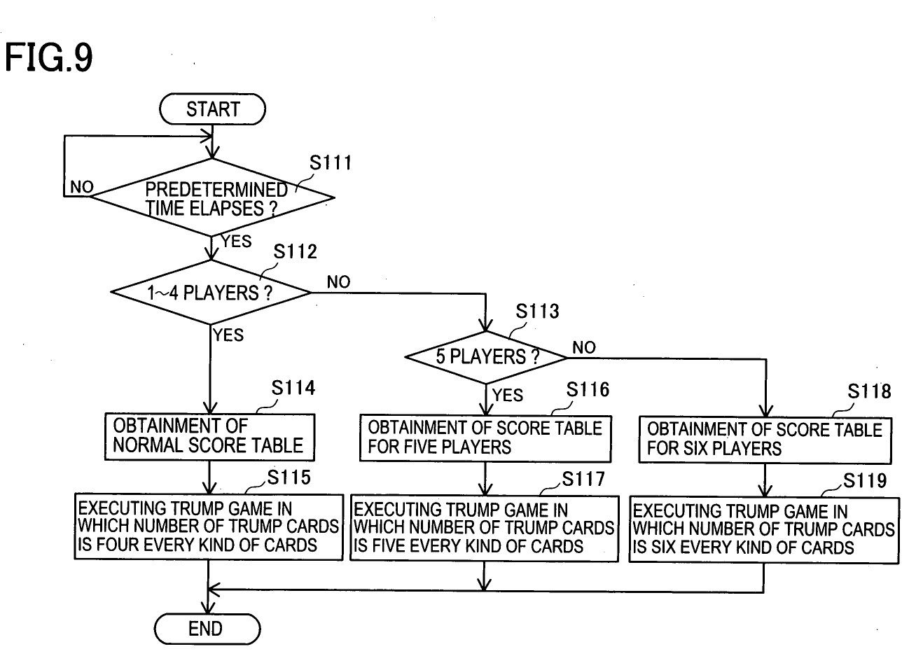

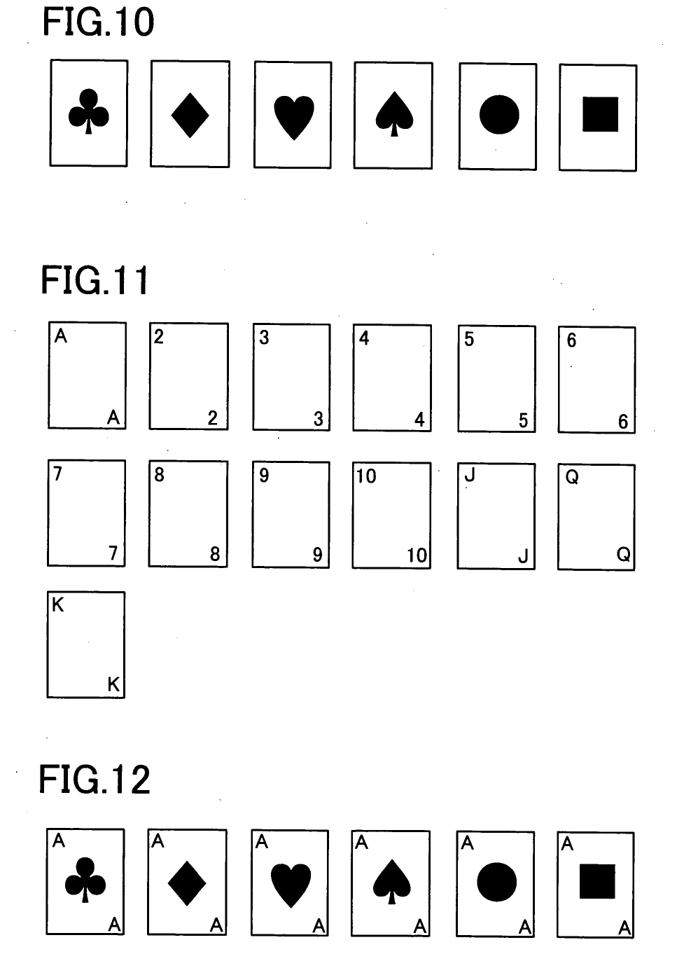

And a part of the main program executed by the CPU 31 in the gaming machine 101 of the embodiment should be changed to that for the trump game. FIG. 9 is a flowchart showing a part of the main program. In the gaming machine 101 according to the embodiment, as shown in FIG. 9, at first, procedure waits till a predetermined time (for example, one minute) elapses in S111. And if it is determined that the predetermined time elapses (S111: YES), an entry number is determined in S112 and S113.

Here, the entry number is determined based on the number of the operation buttons 17f pressed in each of the first to sixth control panels 15A, 15B, 15C, 15D, 15E and 15F till the predetermined time in S111 elapses.

If it is determined that the entry number lies in a range of one player to four players (S112: YES), procedure shifts to S114. In S114, the normal score table stored in the normal score table area 322B of the ROM 32 is obtained and stored in the work area of the RAM 34. Procedure further shifts to S115 and the trump game control program stored in the normal trump game area 325B of the ROM 32 is obtained and stored in the work area of the RAM 34 and such trump game program is executed. Thereby, thereafter image data of thirteen trump cards on which each of ranks A, 1, 2, 3, 4, 5, 6, 7, 8, 9, 10, J, Q and K is described and image data of four trump cards on which each suit of club, diamond, heart and spade is described are synthesized, as a result, the normal trump card game using total 52 trump cards is conducted. That is to say, the normal trump game, in which the number of the trump cards becomes four every kind of the trump cards based on the operation signals output from the operation buttons 16, 17 on the first to sixth control panels 15A, 15B, 15C, 15D, 15E and 15F, is conducted as the video game and scores are calculated according to the normal score table.

On the other hand, if it is determined that the entry number is five players (S112: NO, S113: YES), procedure shifts to S116 and the score table for five players stored in the score table area 323B of the trump game with five players of the ROM 32 is obtained and stored in the work area of the RAM 34 and procedure shifts to S117. In S117, the trump game control program stored in the trump game area 326B of the trump game with five players is obtained and stored in the work area of the RAM 34 and such trump game control program is executed. Thereby, thereafter image data of thirteen trump cards on which each of ranks A, 1, 2, 3, 4, 5, 6, 7, 8, 9, 10, J, Q and K is described and image data of five trump cards on which each suit of club, diamond, heart, spade and circle is described are synthesized, as a result, the trump card game with five players using total 65 trump cards is conducted. That is to say, based on the operation signals output from the operation buttons 16, 17 on the first to sixth control panels 15A, 15B, 15C, 15D, 15E and 15F, the trump game with five players, in which the number of the trump cards becomes five every kind of the trump cards, is conducted as the video game and scores are calculated according to the score table for five players.

And if it is determined that the entry number is six players (S112: NO, S113: NO), procedure shifts to S118 and the score table for six players stored in the score table area 324B of the trump card game with six players of the ROM 32 is obtained and stored in the work area of the RAM 34 and procedure shifts to S119. In S119, the trump game control program stored in the trump game area 327B of the trump game with six players of the ROM 32 is obtained and stored in the work area of the RAM 34 and such trump game program is executed. Thereby, thereafter image data of thirteen trump cards on which each of ranks A, 1, 2, 3, 4, 5, 6, 7, 8, 9, 10, J, Q and K is described and image data of six trump cards on which each suit of club, diamond, heart, spade, circle and square is described are synthesized, as a result, the trump card game with six players using total 78 trump cards is conducted. That is to say, based on the operation signals output from the operation buttons 16, 17 on the first to sixth control panels 15A, 15B, 15C, 15D, 15E and 15F, the trump game with six players, in which the number of the trump cards becomes six every kind of the trump cards, is conducted as the video game and scores are calculated according to the score table for six players.

Here, if it is determined in S112 that the entry number is zero (0), procedure returns to S111 and again waits till the predetermined time elapses although not shown in FIG. 9.

That is to say, in the above case, if the number of players participating in the trump game lies within a range of one player to four players (S112: YES), the normal trump game with four players, in which the number of the trump cards becomes four every kind of the trump cards, is conducted as the video game and scores are calculated according to the normal score table (S114, S115). And if the number of players participating in the trump game is five (S112 NO, S113: YES), the trump game with five players, in which the number of the trump cards becomes five every kind of the trump cards, is conducted as the video game and scores are calculated according to the score table for five players (S116, S117). Further, if the number of players participating in the trump game is six (S112 NO, S113: NO), the trump game with six players, in which the number of the trump cards becomes six every kind of the trump cards, is conducted as the video game and scores are calculated according to the score table for six players (S118, S119).

Therefore, in the gaming machine 101 of the embodiment, since the trump cards utilized in the trump game as the video game and the score table are determined corresponding to the number of players participating in the trump game, it can be expected a new game development with a mutually different strategy and sense of rhythm according to the number of players participating in the trump game even if one kind of the video game such as the trump game is conducted.

And in the gaming machine 101 of the embodiment, if the number of players participating in the mah-jong game lies within a range of one player to four players, the number of the mah-jong pieces (number pieces and character pieces) becomes four every kind of the mah-jong pieces, thereby the mah-jong game with four players is conducted as the video game and scores are calculated according to the normal score table (S14, S15). However, it may be conceivable that if the number of players participating in the mah-jong game is two, the mah-jong game with two players, in which the number of the mah-jong pieces becomes two every kind of the mah-jong pieces, is conducted as the video game and scores are calculated according to the score table for two players, without compensating the players lacking in the mah-jong game with four players by the automatic control through the CPU 31. Similarly, it may be conceivable that if the number of players participating in the mah-jong game is three, the mah-jong game with three players, in which the number of the mah-jong pieces becomes three every kind of the mah-jong pieces, is conducted as the video game and scores are calculated according to the score table for three players, without compensating the players lacking in the mah-jong game with four players by the automatic control through the CPU 31. This situation similarly exists in a case that various trump games are conducted in the gaming machine 101, instead of the mah-jong game.

Further, in the gaming machine 101, the image data of the mah-jong pieces may be formed as follows. Namely, the image information of the mah-jong pieces (number pieces and character pieces) is stored in the ROM 32 beforehand, and the CPU 31 forms the image data of the mah-jong pieces on the basis of the image information of the mah-jong pieces. Further, the CPU 31 increase or decrease the number of the mah-jong pieces the image data of which are formed according to the above, corresponding to the number of players participating in the mah-jong game determined in S12, S13 (four players if S12: YES, five players if S12: NO and S13: YES, six players if S12: NO and S13: NO).

And in the gaming machine 101 according to the embodiment, although the players who can participate in the mah-jong game are limited to the players sitting on the first to sixth seats 102A, 102B, 102C, 102D, 102E and 102F in the first to sixth gaming places 110A, 110B, 110C, 110D, 110E and 110F provided in the game table 200, if the mah-jong game is conducted through a network, the players may participate through the network. This situation similarly exists in a case that various trump games are conducted in the gaming machine 101, instead of the mah-jong game.

Further, in the gaming machine 101 according to the embodiment, six shelter plates 202 dividing each of the first to sixth gaming places 110A, 110B, 110C, 110D, 110E and 110F may be produced by polarization plates. Also in this case, due to the shelter plates 202 constructed from the polarization plates, the players cannot recognize contents displayed on each of the display screens 13A, 13B, 13C, 13D, 13E and 13F and the operation state in the first to sixth control panels 15A, 15B, 15C, 15D, 15E and 15F.

As mentioned in the above, the present invention can be adopted for a gaming machine conducting a video game in which the number of participants (players) can be changed.

What is claimed is:

1. A gaming machine comprising:
a display device for displaying image data of game tools;
a first memory for storing a plurality of score tables each of which is formed corresponding to a number of players participating in a game;
a second memory for storing the image data of the game tools;
a first determination device for determining the number of the players participating in the game;
a second determination device for determining a number of the game tools corresponding to the number of the players determined by the first determination device;
a table selection device for selecting one of the score tables stored in the first memory based on the number of the players determined by the first determination device; and
a game control device for executing the game based on the number of the game tools determined by the second determination device and the score table selected by the table selection device while controlling the display device so as to display the image data of the game tools corresponding to the number thereof determined by the second determination device.

2. The gaming machine according to claim 1, further comprising:
a plurality of input devices through which the players input entry signals during a game entry time;
wherein the first determination device determines the number of the players participating in the game based on a number of the entry signals input from the input devices by the players.

3. The gaming machine according to claim 2, wherein a proper number of the players participating in the game is predetermined for the game, and
wherein the game control device compensates at least one hypothetical player so that the number of the players reaches to the proper number if it is determined by the first determination device that the number of the players is less than the proper number.

4. The gaming machine according to claim 2, wherein the game is a mah-jong game.

5. The gaming machine according to claim 4, wherein the game tools are mah-jong pieces utilized in the mah-jong game.

6. The gaming machine according to claim 5, wherein the image data stored in the second memory are image data of the mah-jong pieces.

7. The gaming machine according to claim 2, wherein the game is a trump game.

8. The gaming machine according to claim 7, wherein the game tools are trump cards utilized in the trump game.

9. The gaming machine according to claim 8, wherein the image data stored in the second memory include trump card suit image data and trump card rank image data.

10. The gaming machine according to claim 9, further comprising:
a read out device for reading out the trump suit image data and the trump card rank image data from the second memory;
a formation device for forming the image data of the trump cards by combining the trump card suit image data and the trump card rank image data read out by the read out device based on the number of the trump cards determined by the second determination device.
